(19) United States
(12) Patent Application Publication
(10) Pub. No.: US 2008/0169316 A1
(43) Pub. Date: Jul. 17, 2008

(54) TUBE WITH PRESSURIZED SPRING-LIKE ACTION AND VACUUM LOCK REGULATOR FOR RENDERING OPTIMUM LIQUID EXTRACTION AND UNINTERRUPTED ON-COMMAND VERTICAL AND HORIZONTAL OPERATION AND A METHOD FOR RETROFITTING A LIQUID DISPENSING DEVICE WITH SUCH TUBE

(76) Inventor: Jeffrey R. Ganiere, New Berlin, WI (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(21) Appl. No.: 11/622,652

(22) Filed: Jan. 12, 2007

(51) Int. Cl. B67D 5/60

(52) U.S. Cl. 222/464.3; 29/402.08

(57) ABSTRACT

A dense and non-buoyant tube with spring-like action for use with a liquid-dispensing container and sprayer mechanism is configured with a flat transversely-cut end that includes an aperture in it, referred to as a vacuum-lock regulator valve, whereby the end of the tube is unable to create a complete suction attachment to the bottom of the container. The spring-like tube of the present invention is also provided as part of an assemblage, the tube being used within a method for retrofitting liquid-dispensing containers of original manufacture.

### FIELD OF THE INVENTION

This invention relates generally to containers, especially hand-held liquid-dispensing containers of the type that are used for dispensing liquid products by means of a sprayer or atomizer mechanism that is attached to an upper portion of the container. It also relates generally to the type of tubing that is used in such containers to draw the liquid product out of the container.

More particularly, this invention relates to a new and useful tube having a spring-like action that can more efficiently reach all bottom surface portions of the inside of a liquid-dispensing container to optimize liquid product extraction and to minimize liquid product wastage. It also relates to an assemblage and to a method whereby the tube with its spring-like action can be used to retrofit existing and/or future liquid-dispensing containers of original manufacture.

### BACKGROUND OF THE INVENTION

Liquid-dispensing containers and spray bottles are well known. Such bottles or containers are used in multifarious industries including, but not limited to, household products, food products, medical products, personal hygiene, perfumes, paints, cleaning products, liquid waxes, automotive products, commercial products, personal care products, and so on. In short, such bottles or containers are omnipresent and can be found in the kitchen, bathroom, basement and garage of every household, and in almost every business and commercial setting, and are fabricated in an almost infinite number of shapes and sizes.

Such bottles or containers typically utilize a “trigger” or “fingertip” pump spray mechanism that is mounted atop the neck of the container or bottle by suitable means, such as by screw threads. The trigger or pump spray mechanism provides the user with “on command” (or “on demand”) spray capability when the trigger is finger-actuated. A necessary part of the typical liquid-dispensing container is that the spray mechanism or pump sprayer have attached to it a rigid tube that extends downwardly and inwardly into the container or bottle, the distal end of the tube being situated such that it is intended to be placed below the level of the liquid or fluid that is contained within the bottle or container such that liquid product is dispensed when the spray mechanism is actuated.

Such conventional rigid tubing is, however, profoundly limited in its ability to satisfactorily and adequately dispense liquid product from hand-held liquid dispensing containers. In the experience of this inventor, conventional rigid tubing is not capable of sufficiently dispensing liquid product when the liquid dispensing mechanism, and its container, is tipped or tilted, especially when the volume of liquid product that is held within the container reaches lower levels.

Manufacturers haphazardly attempt to correct this problem via offering an optional extended rigid tube that jams the distal end of the tube into a fixed position in the bottom of the container. The problem with this unsatisfactory remedy is that the distal end of the tube remains constantly fixated in only one location in the bottom of the container.

In that situation, the immobile distal end of the rigid tubing may be directed even further away from the pool of liquid that is contained within the bottom of the liquid-dispensing container. Regardless of the size and shape of the container, much wasted liquid product will remain within the liquid-dispensing container when the conventional rigid tubing is simply not situated in proper orientation relative to the liquid that is contained within the container.

In the view of this inventor, the foregoing inadequacies of conventional rigid tubing makes the use of such tubing environmentally unfriendly because the rigid tubing completely fails to offer a satisfactory means for optimum liquid depletion from liquid dispensing containers.

Mere casual investigation reveals that over the past several decades hundreds of millions of dissatisfied consumers have collectively wasted untold billions of their hard earned dollars via helplessly squandering multi-billions of gallons of liquid product. This tragic economic and ecological disaster has and, moreover, continues as a result of indispensable and misspent liquid product in direct consequence of deficient dispensing capabilities. The same consumers also have had to endure many years of aggravated daily frustration due to substandard dispensing qualities related to rigid tubing. Additionally, market research indicates with exact precision that liquid product manufactures have grossly underestimated their current customer's voracious desire for improved horizontal liquid delivery performance including the convenience and dramatic cost saving advantages affiliated with obtaining maximum liquid product depletion and avoiding misspent spraying.

Over the past thirty (30) years, quantum-leap technologies have enriched, refined and enhanced our way of life helping to better our world. Many of these high-tech benefits are also yielding us a much safer and cleaner environment. In light of these super technological marvels, the liquid product and liquid dispensing industry still fail to provide a simple low-tech tool affording continuous on-command horizontal liquid product dispensing capability and maximum liquid product depletion to circumvent indisputably preventable liquid product waste.

Indeed, the existence of Twenty-First Century environmental issues demands that there be an immediate world-wide adaptation of a cost effective means to eliminate the inexcusable 5% to 15% or even greater, amount of wasted liquid product that is commonly left in the bottom of liquid-dispensing containers that employ functionally inadequate conventional rigid tubing.

Also in this inventor's experience, the use of conventional rigid tubing leads to the inexcusable wastage of liquid at an even greater, though less obvious, level. That is, the use of conventional rigid tubing in liquid-dispensing containers of current manufacture also fails to provide a means for accurately spraying the intended target due to incessant loss of prime, thus accounting for radically substantial additional percentages of wasted liquid product. As alluded to earlier, this problem exists because the conventional rigid tubing terminates at a fixed given point within the liquid-dispensing container. Where that tubing terminates, depending upon the orientation of the container and the amount of liquid product remaining within the container, determines how effective the liquid product contents can be accurately dispensed and fully depleted from the container. Typically, as the liquid level drops to a certain level within the container, the conventional rigid tubing will only be able to draw air into it (loss of prime), instead of liquid when the container is tipped in various horizontal positions. This results in the interruption of “on command” spraying of the liquid product causing the operator to compensate with frequent over-spraying, under-spraying and re-spraying of the intended target, thus unwittingly wasting additional and, moreover, substantial amounts of liquid and also frustrating the operator in the process.

Accordingly, untold millions of gallons of unused or, moreover, completely wasted liquid product are wantonly spilled or disbursed into the environment each and every year due to the continued use of wholly antiquated conventional rigid tubing. In addition, copious amounts of soaps, waxes, bleaches, hazardous chemicals, toxins and other such pollutants are recklessly and perpetually remanufactured to counterbalance this senseless wastage of liquid product.

From the perspective of the liquid manufacturer, it appears that it is most likely indifferent as to whether or not all of its liquid product is being fully depleted or properly dispensed because product sales are obviously increased in situations where liquid product is not completely depleted from the container or where liquid product is simply wasted due to under-spraying, over-spraying and/or re-spraying. Accordingly, there is little internal incentive for a liquid manufacturer to utilize a better tube to maximize the removal of liquid from within the container and to prevent the unnecessary spilling and spraying of chemicals and toxins into our fragile ecosystem. If the incentive does not come from within, then it must come from consumer, government and environmental group pressure that is applied directly to those responsible for allowing this unjustifiable condition to continue.

Finally, it should be understood that most trigger and pump sprayers have a shelf life of perhaps five or more years and a fully functional working life that is capable of dispensing perhaps as much as ten times or more of the amount of liquid product that is supplied in the original liquid-dispensing container. In the view of this inventor, this situation accounts for the needless and premature disposal of a perfectly functional device. As a result, profuse amounts of plastics, chemicals, toxins and other such pollutants are needlessly and continuously remanufactured to counterbalance this senseless premature disposal of working trigger/pump sprayers generating another profound and woefully negative impact on both natural resources and the environment in general. In addition, most, if not all, liquid dispensing devices such as plastic trigger sprayers and pump sprayers are not recyclable due to the non-recyclable mixture of internal mechanisms which incorporate metal springs, metal ball check valves and other such materials that would require tedious and cost ineffective separation from one another in the recycling process. Subsequently, all of these complete liquid-dispensing devices must be disjoined from the liquid-dispensing container that they are affixed to and disposed of separately into landfills. This also accounts for untold millions upon millions of liquid-dispensing devices that are, in this inventor's view, needlessly filling up precious landfill space due to premature disposal of such trigger sprayers and pump sprayer mechanisms. The recommended remedy is to encourage reuse of fully functional trigger and pump sprayers via mass introduction of wholly recyclable refill containers

It should also be mentioned that prior art devices have been configured to provide various structures for the depletion of liquid product within a liquid-dispensing container. Several such devices from separate issued patents use a weighted end of a tube whereby the weighted tube end is drawn by gravity to the lowest point within the container when the container is tipped, with the notion that liquid within the container will be drawn, also by gravity, to that same point of the container. However, such prior art devices are typically neither practical nor cost-effective for mass production. Moreover, such prior art devices simply do not claim to nor can they achieve maximum liquid depletion virtually down to the last few droplets.

In point of fact, all previous art fails to teach a simple liquid delivery system that is practical, that is cost-effective for mass production, and that achieves maximum liquid product depletion. None of the prior art devices teach a liquid delivery system having a tube with spring-like action that has sufficient density and flexibility wherein the flexible “spring-like” tube is fully functional in and of itself without the need for any weights, weight blockers, bottle adapters, dissolvable external rigid coatings, or any special devices for retaining the flexible tube. None teaches an elongated spring-like flexible tube that is capable of allowing the distal end of the tube to remain mobile and yet, firmly affixed to all interior bottom surface areas of the container for the purpose of obtaining maximum liquid product depletion with means incorporated within the tube for eliminating the potential for liquid suction blockage.

### SUMMARY OF THE INVENTION

Accordingly, the primary objectives of the present invention are to provide a new, useful and uncomplicated tube with “spring-like” action for use within a liquid-dispensing container, the tube being configured to replace conventional rigid tubing, whereby liquid product extraction is optimized, uninterrupted multidirectional spraying ability is realized, and the ability to directly spray the intended target without over-spray or under-spray is vastly improved.

It is a further object of the present invention to provide such a spring-like tube that extends well into the interior bottom corners of the container to assure the substantially complete depletion of the liquid product from the container, the spring-like tube being readily useable within liquid-dispensing containers of current manufacture. It is yet another object of the present invention to provide such a spring-like tube that facilitates the complete liquid depletion from within the liquid-dispensing container, save for all but a few remaining droplets, when the sprayer mechanism and container is oriented to spray liquid in a wide variety of horizontal positions. It is still another object of the present invention to provide such a spring-like tube that includes a “vacuum-lock regulator” structure which is disposed at the bottom-most end of the tube to prevent the tube from adhering to an inner surface of the container and thereby creating a vacuum-lock within the tube such that no liquid is drawn into the tube.

It is yet another object of the present invention to provide a means for replacing the original conventional rigid tube within existing and/or future sprayer mechanisms and liquid-dispensing containers of original manufacture with a spring-like tube that is constructed in accordance with the foregoing objects.

The spring-like tube of the present invention has obtained these objects. It provides for a tube that is made of a spring-like material having a higher density than that of the liquids with which the tube would be used. The spring-like tube of the present invention is, by its relative weight, flexibility, length and specific gravity, capable of extending into the furthermost corners of a liquid-dispensing container to achieve maximum liquid depletion from virtually every bottom surface point within the container. The spring-like tube of the present invention is also configured with a flat transversely and perpendicularly-cut or formed end that includes a longitudinally-extending aperture in it, also referred to herein as a “vacuum-lock regulator valve,” such that the end of the spring-like tube is unable to create a complete vacuum attachment to an inner surface of the liquid-dispensing container. That is, the spring-like tube of the present invention includes an aperture defined within the end of the tube whereby it is impossible to create a complete suction vacuum at that tube end, which suction vacuum would otherwise effectively attach the distal tube end to the floor or bottom of the container and impede liquid product flow within the tube. The spring-like tube of the present invention is also provided as part of an assemblage, the tube being used within a method for retrofitting existing and/or future liquid-dispensing containers of original manufacture.

The foregoing and other features of the spring-like tube and the assembly and method for using the spring-like tube as an after-market item in accordance with the present invention, will be apparent from the detailed description that follows.

### BRIEF DESCRIPTION OF THE DRAWINGS

FIG. 1 is a left side elevational view of a liquid-dispensing container constructed in accordance with the prior art.

FIG. 2 is another left side elevational view of the liquid-dispensing container shown in FIG. 1 and illustrating the container in a slightly “tipped” position.

FIG. 3 is a left side elevational view of another liquid-dispensing container constructed in accordance with the prior art.

FIG. 4 is another left side elevational view of the liquid-dispensing container shown in FIG. 3 and illustrating the container in a slightly “tipped” position.

FIG. 5 is a left side elevational view of a liquid-dispensing container that uses a spring-like tube constructed in accordance with the present invention.

FIG. 6 is another left side elevational view of the liquid-dispensing container illustrated in FIG. 5 and showing the container in a slightly “tipped” position.

FIG. 7 is another left side elevational view of the liquid-dispensing container illustrated in FIG. 5 and showing the container in a fully rearwardly “tipped” horizontal position.

FIG. 7 is another left side elevational view of the liquid-dispensing container illustrated in FIG. 5 and showing the container in a fully forwardly “tipped” horizontal position.

FIG. 8 is right side elevational view of the liquid-dispensing container illustrated in FIG. 5 and showing the container in a rearwardly “tipped” fully horizontal position.

FIG. 9 is a front elevational view of the liquid-dispensing container illustrated in FIG. 5 and showing the container “tipped” to the left and in a fully horizontal position.

FIG. 10 is a front elevational view of the liquid-dispensing container illustrated in FIG. 5 and showing the container “tipped” to the right and in a fully horizontal position.

FIG. 11 is a packaged assemblage for a plurality of the spring-like tubes of the present invention.

FIG. 12 is an enlarged left side elevational view of a manual trigger-type sprayer and showing the rigid tube of original manufacture being severed.

FIG. 13 is a view of the sprayer shown in FIG. 8 and illustrating friction fit attachment of one end of the spring-like tube of the present invention to the remaining suction tube of that sprayer.

FIG. 14 is a left side elevational view of the spring-like tube of the present invention as attached to the sprayer and held next to the liquid-dispensing container following cutting of the second tube end.

FIGS. 15A and 15B are greatly enlarged bottom and front perspective views of the vacuum-lock regulator valve or aperture located at the suction end of the spring-like tube of the present invention.

FIG. 16 is a view similar to those shown in FIGS. 12 and 13 but illustrating a female-type attachment of the spring-like tube to the underside of the original sprayer.

FIG. 17 is a sectional view of the lower most portion of the spring-like tube of the present invention and showing the flow of liquid or fluid at the bottom of the liquid-dispensing container as passing through the vacuum regulator valve or aperture.

FIG. 17A is an enlarged side sectional view of the lower most portion of the spring-like tube taken along line 17A-17A of FIG. 17.

FIG. 17B is a further enlarged front sectional view of the lower most portion of the spring-like tube taken along line 17B-17B of FIG. 17A.

FIGS. 18A and 18B are left side elevational views of an assembly in accordance with prior art.

FIG. 19 is a left side elevational view of a liquid-dispensing container that uses the spring-like tube of the present invention with a sprayer that is of the “elevator” type.

FIG. 20 is a view similar to that shown in FIG. 19 and showing the spring-like tube being elevated within the liquid-dispensing container.

FIG. 21 is a left side elevational view of a liquid-dispensing container that utilizes a partially severed original rigid tube together with an attached shorter, yet fully functional spring-like tube in accordance with the present invention.

FIG. 22 is a front elevational view of another type of atomizer sprayer that utilizes a spring-like tube in accordance with the present invention.

### DETAILED DESCRIPTION

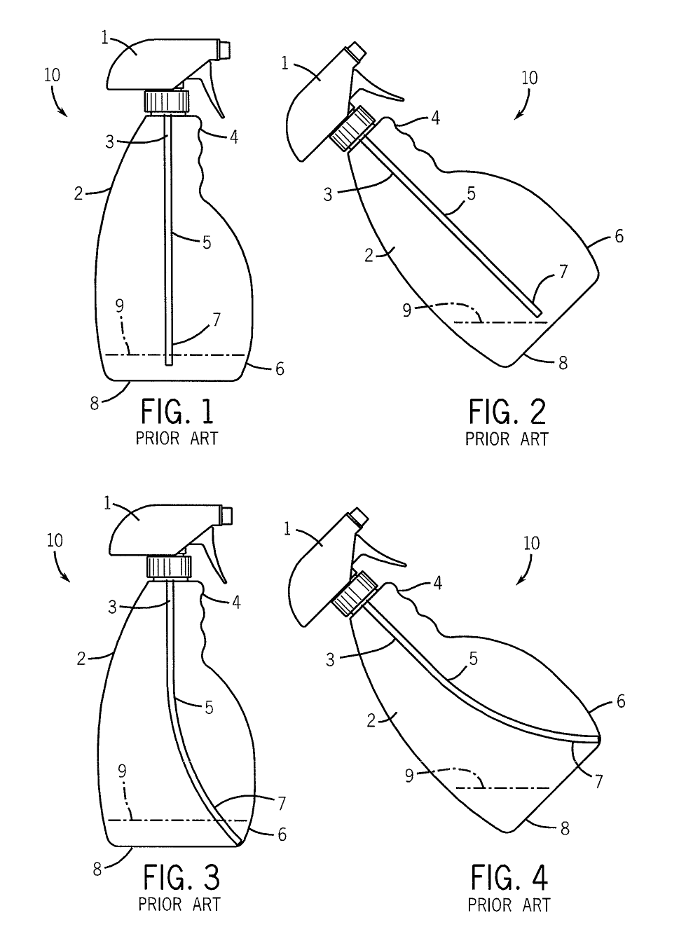

Referring now to the drawings in detail wherein like numbers represent like elements throughout, FIGS. 1 and 2 illustrate a liquid-dispensing container assembly, generally identified 10, that is constructed in accordance with the known prior art. As shown, the assembly 10 comprises a container 2 that includes an uppermost portion 4 and a lowermost portion 6. The liquid-dispensing container 2 also includes a generally flat bottom surface 8 that allows the liquid-dispensing container 2 to rest upon a flat horizontal surface. Attached to the uppermost portion 4 of the liquid-dispensing container 2 is a trigger-type sprayer mechanism 1. Extending downwardly from the sprayer mechanism 1 is a conventional straight rigid tube 5 of original manufacture that is also fabricated in accordance with the known art. The straight rigid tube 5 includes an upper portion 3, the upper portion being attachable to the sprayer mechanism 1 and a lower portion 7, the lower portion 7 extending downwardly into the lower-most portion 6 of the container 2. In this fashion, the lower end 7 of the tube 5 extends below the level of a liquid 9 that is contained within the container 2. As shown in FIG. 2, use of this prior art liquid-dispensing assembly 10 is compromised, and the “on demand” dispensing of the liquid from within the container 2 is interrupted, when the liquid-dispensing container 2 is tipped backwardly at an angle, for example. As shown, this can result in the lowermost portion 7 of the straight rigid tube 5 not being able to reach into the reservoir of liquid 9 that is contained within the lowermost portion 6 of the container 2. This is problematic for a number of reasons. First of all, this position results in user frustration and the inability of the sprayer mechanism 1 to draw fluid 9 up the tube 5 resulting in loss of prime. In order to regain prime, the user must position the container 2 in the upright vertical posture and squeeze the trigger or pump mechanism 1 several times until the liquid resumes a normal spray pattern. During this all too frequent and frustrating re-priming process, the operator most likely will over-spray, under-spray or entirely miss his or her target because the sprayer, now being in the upright vertical posture, is no longer aimed at the intended target. Another problem with this is that this “tipped” position results in incomplete use of the liquid or fluid contents 9 of the container 2, and thus wasting of a substantial portion of fluid or liquid within the container 2. Other problems of wastage and environmental impact, as alluded to earlier in this specification, are also directly caused by this substantially flawed prior art device.

FIGS. 3 and 4 illustrate another liquid-dispensing container assembly, generally identified 10, which is also constructed in accordance with the known prior art. As shown, this assembly 10 comprises a container 2 that includes an uppermost portion 4 and a lowermost portion 6. The liquid-dispensing container 2 also includes a generally flat bottom surface 8 which allows the liquid-dispensing container 2 to similarly rest upon a flat surface. Attached to the uppermost portion 4 of the liquid-dispensing container 2 is a trigger-type sprayer mechanism 1. Extending downwardly from this sprayer mechanism 1 is an optional extended version of rigid tube 5 offered by numerous manufacturers. This optional extended rigid tube 5 is an ill-contrived attempt to remedy the shortcomings of the shorter rigid tube 5 because the distal end 7 of the extended tube 5 is also immobile and thus, fixated at only one inner bottom surface 8 position. Consequently, as is shown in FIG. 4, the problem is not solved at all since “on-demand” dispensing of the liquid within the container 2 is similarly interrupted when the liquid-dispensing container 2 is tipped backwardly at the angle illustrated. As shown, this configuration continues to result in the lowermost portion 7 of the extended rigid tube 5 not being able to reach into the reservoir of liquid 9 that is contained within the lowermost portion 6 of the container 2. As shown, the use of the extended rigid tube 5 can be seen to actually worsen performance since only a slight tipping of the container 2 would result in the inability of the lowermost portion 7 of the extended rigid tube 5 to reach into the reservoir of liquid 9 that is contained within the container 2.

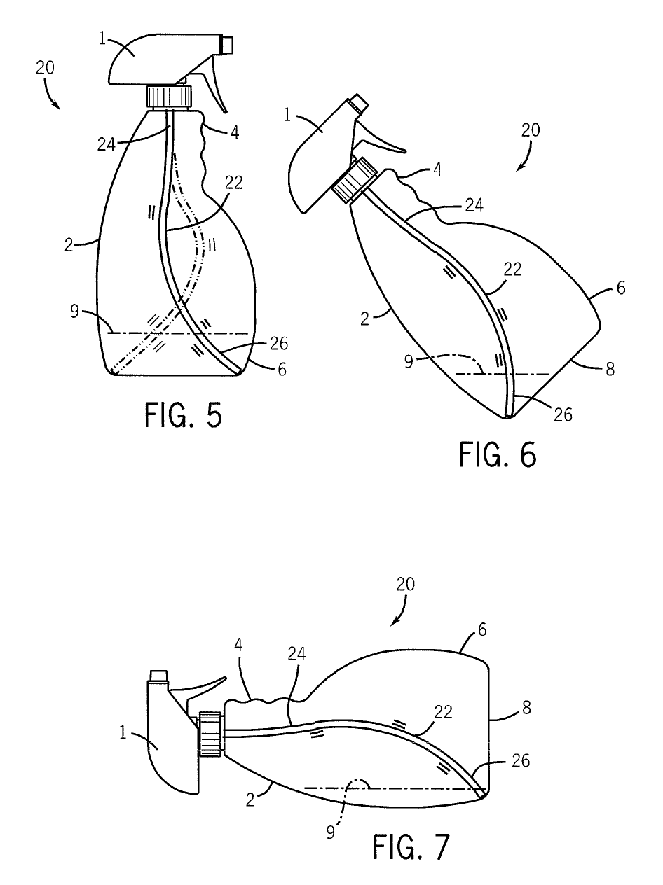

Referring now to FIGS. 5 and 6, these figures illustrate use of a liquid-dispensing container assembly, generally identified 20, in the same positions as shown in their counterpart FIGS. 1 through 4 but wherein the original conventional rigid tube 5 has been replaced with a dense, non-buoyant and spring-like tube 22 that is constructed in accordance with the present invention. As shown, the spring-like tube 22 has an uppermost portion 24, the uppermost portion 24 being attachable to the sprayer mechanism 1 and a lowermost portion 26 that descends into the lowermost corners and recesses of the liquid-dispensing container 2.

Friction-fit is most commonly used with rigid tubing 5. Commonly known assembly methods can be applied to install the spring-like tube 22 to most currently available liquid dispensing mechanisms in like or similar manner to the methods used to install rigid tubing 5. The one-piece spring-like tube 22 can be easily slipped/pressed/inserted over or into any existing rigid male liquid delivery extension on the dispensing device 1 and held in place via friction fit or slipped/pressed/inserted into any existing female liquid delivery aperture on the liquid dispensing device 1 and held in place via friction fit. A suitable adhesive (not shown) can also be applied via commonly known methods to more securely attach the spring-like tube 22 to the dispensing device, if needed. It is absolutely essential that the dense, non-buoyant and spring-like tubing 22 of the present invention be fabricated in such a way that the source tubing is properly cooled in a linearly straight line or formation before being coiled on a shipping reel. This is to ensure that there is no “memory” arcing introduced into the tubing 22 that would impede the ability of full gravity activated travel of the tube 22 within the container 2.

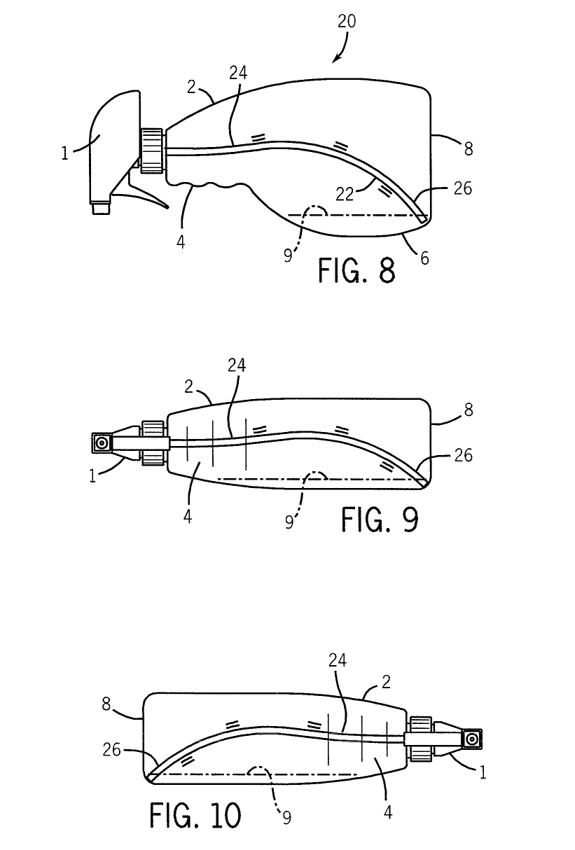

FIGS. 7 through 10 further illustrate the effectiveness of the dense, non-buoyant spring-like tube 22 of the present invention being mobile and thus, able to reach into whatever small amount of liquid product 9 is contained within the container 2. This is true when the container 2 is tipped backwardly even to the point of being in a fully horizontal position as shown in FIG. 7, when the container 2 is tipped forwardly to a horizontal position as shown in FIG. 8, and when tipped side-ways to a fully horizontal position as is shown in FIGS. 9 and 10. In this fashion, the spring-like tube 22 of the present invention provides uninterrupted “on-demand” flow and maximum liquid product depletion virtually down to the last few droplets, even when the liquid-dispensing container 2 is tipped or tilted in the horizontal positions shown in FIGS. 7 through 10.

It should also be noted that the dense, non-buoyant and spring-like tube 22 of the present invention keeps the suction end 26 of the tubing 22 firmly affixed in squeegee-like fashion to the bottom 8 of the container 2 as liquid product 9 nears depletion to accomplish maximum liquid product depletion. That is, the spring-like tube 22 of the present invention overcomes the flawed design of conventional rigid tubing 5 by allowing the suction end 26 of the dense, non-buoyant “spring-like” tube 22 to remain constantly submerged in the liquid and also firmly affixed to the bottom surface areas 8 of the container 2, thus affording maximum liquid product depletion and eliminating wastage of liquid product 9.

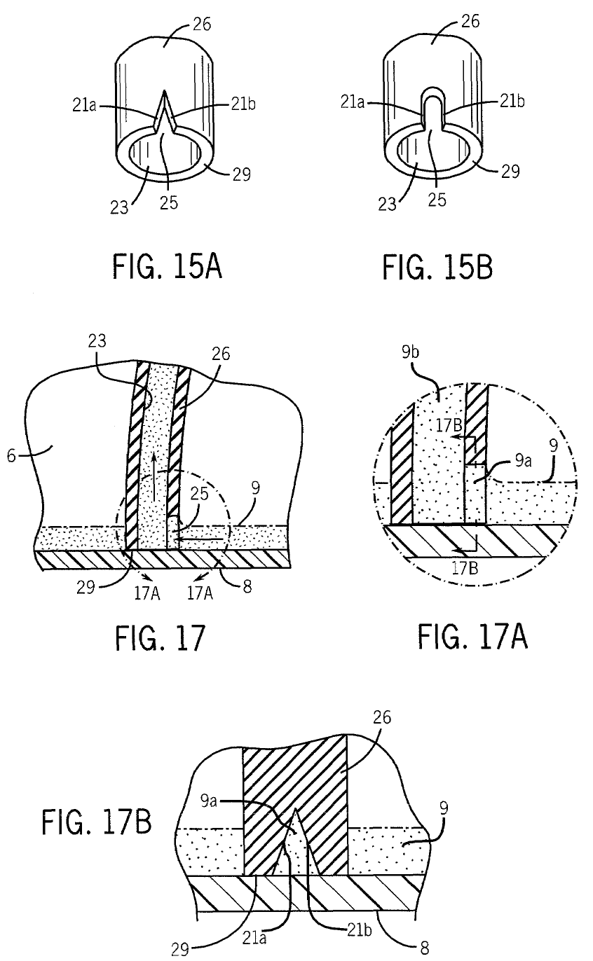

The spring-like tube 22 of the present invention can become positioned within the container 2 such that the suction end 26 of the tube 22 rests squarely at the bottom 8 of the liquid-dispensing container 2. Referring now to FIGS. 15A, 15B and 17, they illustrate another significant aspect of the spring-like tube 22 of the present invention. Specifically, FIG. 15A illustrates the lowermost portion 26 of the spring-like tube 22 wherein the lowermost portion 26 of the tube 22 includes a lowermost “O-shaped” and transversely and perpendicularly-disposed flat surface 29. If this flat surface 29 was left alone, a complete suction interruption, or “suction blocking,” could occur whenever the flat surface 29 of the lowermost portion 26 of the tube 22 would come into full contact with the flat bottom 8 of the bottle 2. However, to one side of the lowermost portion 26 of the spring-like tube 22, two angled cuts or a molded formation 21a, 21b are made within the tube 22 to form a generally V-shaped notch 25, also referred to earlier in this application as the “vacuum-lock regulator valve” or aperture 25 that is located at the suction end 26 of the spring-like tube 22. As is shown in FIG. 15B, the notch 25 could include a more “rounded” profile and still come within the functional requirements of the spring-like tube 22 of the present invention. Various configurations of the notch or “vacuum lock regulator valve” 25 will also work as will varied configurations of the lowermost portion 26 and the flat surface 29 of the tube 22 and are anticipated by this inventor. As shown in FIG. 17, the utilization of the vacuum-lock regulator valve 25 allows the lowermost surface 29 of the spring-like tube 22 to be in full squeegee-like contact with the bottom 8 of the container 2 in such a way that would, absent the vacuum-lock regulator valve 25, otherwise prevent the flowing of liquid 9 within the internal aperture 23 of the tube end 26. It would also be possible to incorporate a plurality of such valves 25 within the lowermost portion 26 of the tube 22, the formation of a single aperture for this purpose not being a limitation of the present invention.

The primary function of the vacuum-lock regulator valve 25 is to provide a somewhat wider liquid opening at the bottom of the distal tube end 26 and a more restricted and tapered liquid gap opening towards the top of the valve 25. This design allows liquids to flow into the entire vacuum-lock regulator valve 25 when the bottom tube surface 29 is totally restricted. However, this design innovation also allows for maximum liquid product depletion because liquid product 9 will follow the path of least resistance which is the larger inner surface diameter 23 of the tube 22. Liquid is also much more dense than air. Subsequently, under normal unrestricted suction conditions, the liquid 9a forms within the uppermost portion of the vacuum-lock regulator valve or aperture 25, performing as a continuation of the tubing 22 subsequently allowing the liquid 9b to be drawn up and into the larger and less restricted inner surface 23 of the tubing 22. See FIGS. 17, 17A and 17B. Thus, any potential complete vacuum or suction interruption is remedied by means of the vacuum-lock regulator valve or aperture 25 disposed at the tube end 26.

In the preferred embodiment, the vacuum-lock regulator valve 25 is configured to be approximately one-sixteenth of an inch wide and one-sixteenth of an inch long. The spring-like tube 22 of the present invention is not, however, limited to those dimensions and other dimensions may be used based upon the size of the liquid-dispensing container 2 or the size of the spring-like tube 22 and/or the particular viscosity of the liquid 9 that is used. Furthermore, the “V” or “U” shaped aperture configurations 25 can be modified. Thus, any variances to the shape, size and/or plurality of the “V” or “U” configurations 25 are already anticipated by this inventor and fall within the entire scope of this invention.

The unique design of the dense, non-buoyant and spring-like tube 22 of the present invention offers an affordable and effective means to dramatically reduce wasted liquid product in liquid dispensing containers 2 to an acceptable level of perhaps as low as one-tenth of one percent. In other words, the tube 22 of the present invention allows liquid depletion virtually down to the last few droplets. The spring-like tube 22 of the present invention can be used in virtually any type of manually-operated and/or hand-held liquid pump/trigger sprayer, or press nozzle sprayer, including pressurized and non-pressurized vessels/containers/dispensers, in addition to those illustrated herein, which are illustrated as examples only and are in no way limiting of the present invention. The design of this flexible spring-like tube 22 is entirely unique to all other previous taught art because it offers a unique “spring-like” action and performance for maximum liquid product depletion and a unique vacuum-lock regulator valve 25 which eliminates vacuum lock or complete suction blocking. The simplicity and victorious operational effectiveness of the spring-like tube 22 of the present invention will undoubtedly generate an overwhelming appeal to original equipment manufacturers (OEM) and will likely encourage them to finally abandon the use of the limited, partially flawed and environmentally unfriendly conventional rigid tubing 5 of the prior art. Furthermore, the spring-like tube 22 of the present invention affords the operator/end user the luxury and convenience of the highly desired uninterrupted “on-demand” flow of liquid from virtually any liquid dispensing device, even when such device is tipped in any horizontal position. The spring-like tube 22 of the present invention overcomes the flawed design of conventional rigid tubing 5 by allowing the suction end 26 of the dense, non-buoyant spring-like tube 22 to remain constantly submerged in the liquid 9 thus eliminating loss of prime and dramatically reducing wasted product when the liquid-dispensing container 2 is operated in the upright vertical and various horizontal positions disclosed herein. The spring-like tube 22 of the present invention also keeps the suction end 26 of the spring-like tube 22 firmly affixed to the bottom of the container 2 with squeegee-like action as the liquid 9 is spent to accomplish maximum liquid product depletion. These highly desired features are successfully accomplished without the need for any weights, weight blockers, pivotal joints, extended elliptical tubing or other such labor-intensive kits, costly attachments or other needless apparatus, extensions, etc. as are apparent in the prior art.

All of this is accomplished by gravitational pull on the dense, non-buoyant and spring-like tube 22, the tube 22 being of sufficient extended length from its attachment to the pump/sprayer device 1 to reach and remain in constant pressurized contact with the bottom surfaces 8 of the liquid-dispensing container 2 as the liquid product 9 becomes depleted. That is, gravitational pull causes the suction end 26 of the dense, non-buoyant tube 22 to move freely and remain in constant contact with any point of the entire bottom surface area of said dispenser even when tipped or tilted in any horizontal position. Gravitational pull also causes the distal end of the tube 26 to perpetually follow the liquid when the container 2 is upright vertical or is tipped or tilted forward, backward or side-to-side. The vacuum-lock regulator valve 25 prevents any suction blockage. The spring-like tube 22 of the present invention is specifically designed to allow the uninterrupted on-command flow of liquid products from nearly any liquid dispensing device. These devices include, but are not limited to, plastic, glass or metal containers; pump sprayers, trigger sprayers; and press-nozzle activated pressurized cans, plastic and glass bottles.

However, in order for the spring-like tube 22 of the present invention to provide optimum performance, it is preferred that the dispensing mechanism and the attached tube be centered over the dispensing container. Most currently available liquid-dispensing containers meet these requirements and thus, such liquid-dispensing containers can be successfully employed with the spring-like tube 22 of the present invention without any changes to their design. All various designs of other liquid-dispensing containers 2 in addition to those that are clearly illustrated in the drawings presented herein are contemplated by this inventor.

In order to be successfully incorporated within any particular liquid-dispensing container 2, and for the dense, non-buoyant and spring-like tube 22 of the present invention to provide optimum performance, it is imperative that the spring-like tube 22 be of proper length. With the delivery end 24 of the spring-like tube 22 attached to the liquid dispensing mechanism 1, and with the liquid dispensing mechanism 1 attached to the liquid-dispensing container 2, the suction end 26 of the spring-like tube 22 should be able to reach and extend slightly beyond all inner surface areas of the bottom 8 of the liquid-dispensing container 2. Determining proper length is relative to commonly known means of measurement and is wholly dependent upon the size, shape and configuration of the container 2.

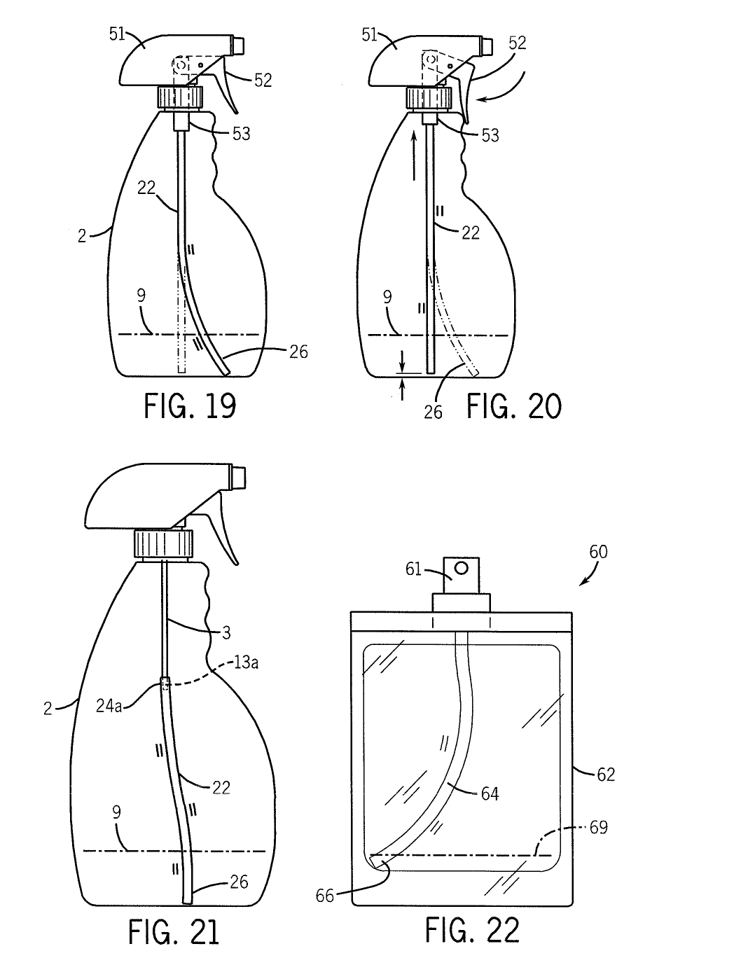

Although not required, the preferred trigger/pump sprayer 51 is the elevating type, as is shown in FIGS. 19 and 20. That is, some liquid dispensing assemblies incorporate an extended male tube port wherein the rigid tube 5 normally inserts into the female opening at the end of the male tube port 53. This particular male tube port 53 design “elevates” approximately three-eighths of an inch when the trigger 52 is squeezed and descends back to normal positioning when the trigger 52 is released. As a result, the suction end 26 of the tube 22 is lifted off of the bottom surface 8 of the container 2 by approximately 1/64^{th} of an inch as the trigger 52 is squeezed allowing wholly unrestricted travel of the tube 22. Spraying occurs on the upstroke when squeezed and suction occurs on the down stroke when released. This scenario is ideal for allowing free travel of the spring-like tube 22 around the entire bottom surface area 8 of the liquid-dispensing container 2. Free tube 22 travel will be restricted if the length is too long and an inability to adequately deplete the liquid contents 9 will result if the tube 22 is too short. Determining the proper length of the one-piece spring-like tube 22 is subject to commonly known means of measurement and is relevant to the size and configuration of the chosen dispensing mechanism and dispensing container used. At proper length, the spring-like tube 22 of the present invention will easily travel around the bottom area of the liquid-dispensing container 2 by means of gravitational pull when tipped forward, backward, or from side to side with or without the preferred elevating type trigger/pump sprayer. The resulting appearance will show the spring-like tube 22 with a bow or curved shape when the trigger mechanism 51 is in the normal released position.

It should be noted at this point that depending upon its specific gravity or density, the spring-like tube 22 might appear to partially “float” somewhat when the liquid-dispensing container 2 is full of liquid (not shown) and is tilted front to back or to one side or another. This is normal in most cases providing that the material make-up of the spring-like tube 22 is composed such that it is harmoniously balanced in both density and flexibility. Whereas, the tube 22 is sufficiently flexible to reach all bottom surface areas 8 of the container 2 and sufficiently dense so that the suction end 26 of the spring-like tube 22 remains totally submerged below the liquid surface level 9 at all times. If properly balanced in material makeup, the tube 22 will lose this “floating” effect as the liquid reaches lower levels. This “floating” effect may not apply to situations where the specific gravity or density of the tube 22 is at higher levels. Accordingly, the spring-like tube 22 material makeup is selected from a group consisting of silicon, rubber, latex, or any other suitable material or a custom blend of compatible materials suitable to meet specific application requirements or requests. Virtually unlimited variations of tubing size, shape and material makeup are readily available in today's market. All variations are included within the scope of this invention. Manufacturers are wholly responsible for procuring and selecting the proper tubing size, wall thickness and material makeup of the tubing to meet these application-specific and liquid product compatibility requirements.

It should also be mentioned here that the spring-like tube 22 of the present invention should preferably be cut at a 90° angle at both ends 24, 26, with the vacuum-lock regulator valve aperture 25 being cut, molded or formed at the suction end 26. These recommended configurations allow the discharge end 24 to be properly seated in the dispensing device 1 where necessary and allow for maximum liquid product 9 depletion of the container 2 at the suction end 26 of the spring-like tube 22. The inside and outside diameters 23 of the spring-like tube 22, with associated tube wall thicknesses, are understood to be perpetually changeable depending upon many variables and specific application requirements. Any variance is within the scope of this invention. The inner and outer tube surface 23 is preferably round and smooth. However, these surfaces and/or tube shapes can be changed and this invention is not limited in that respect.

Another aspect of the spring-like tube 22 of the present invention is that the suction tube 22 can be used as an extension from a shorter length of conventional straight rigid tube 3, as is shown in FIG. 21. Although not necessarily preferred, the spring-like tube 22 of the present invention can be fashioned as an approximate “sixty/forty” or “seventy/thirty” flexible tube 22 and rigid tube 3 assembly, for economic purposes. In this regard, this inventor considers such to be an optional “proportional” solution to the full tube replacement that is preferred within the liquid-dispensing container 2. As shown in FIG. 21, for example, forty percent (40%) of the existing conventional rigid tube 3 of original manufacture is provided and is cut at a point 13a that is substantially lower within the liquid-dispensing container 2. This represents approximately forty percent (40%) of the overall structure of the combined tube 3, 22. On the other hand, the replacement spring-like tube 22 represents about sixty percent (60%) of the overall tube structure 3, 22, the replacement tube 22 being cut at a point 24a. In this way, the interior of the liquid-dispensing container 2 and the liquid product 9 contained within it is still accessed at the distal end 26 of the tube 22 which allows for maximum depletion of the liquid 9 contained within the container 2. Other ratios of original rigid tube 3 to replacement spring-like tube 22 could be used as well and are clearly within the scope of the present invention.

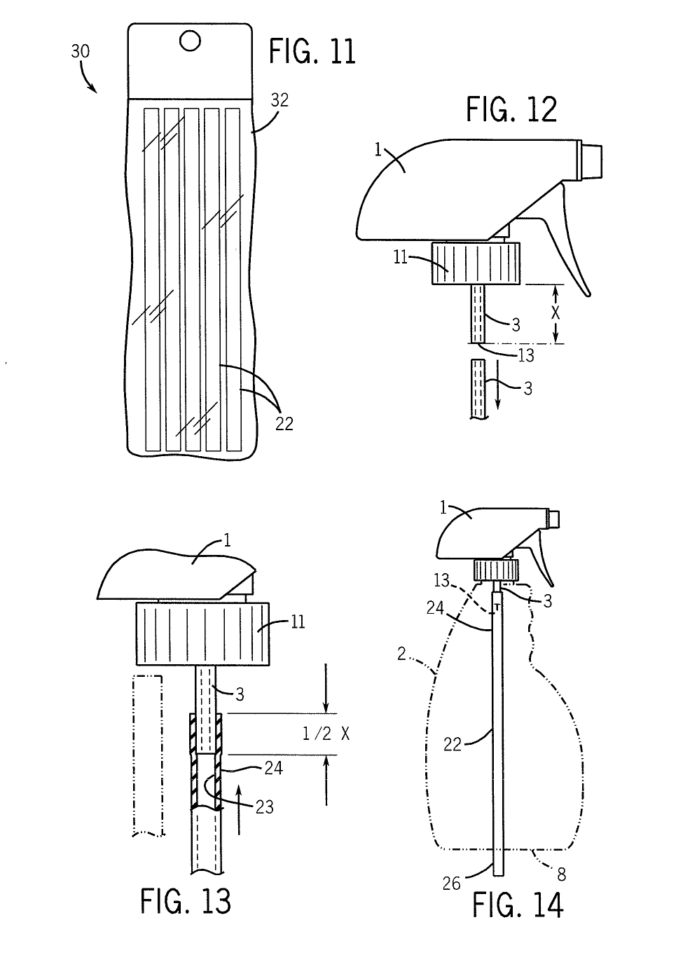

Although the dense, non-buoyant and spring-like tube 22 of the present invention has been considered, up to now, as part of a liquid-dispensing container 2 that is sold as an OEM original part of the assembly 20, it is to be understood that the tube 22 of the present invention could also be sold as part of an assemblage 30 wherein one or more of the spring-like tubes 22 may be included within some sort of after-market packaging 32 for customer purchase. The tubes 22 may be packaged in a variety of application-appropriate sizes. See FIG. 11. As shown, the tubes 22 are packaged such that they can hang or lay straight. Various lengths of tubing 22 can also be coiled (not shown) in a package. It is absolutely essential that the dense, non-buoyant and spring-like tubing 22 of the present invention be fabricated in such a way that the source tubing is properly cooled in a linearly straight line or formation before being coiled on a shipping reel. This is to ensure that there is no “memory” arcing introduced into the tubing 22 that would impede the ability of full gravity activated travel of the tube 22 within the container 2.

The spring-like tube 22 of the present invention can be easily adapted to modify or retrofit virtually any existing (non-pressurized) removable trigger sprayer or pump sprayer via cutting the rigid tube 5 to a length of approximately three-quarters of an inch from the bottom of the twist-on cap 11 on the container 2. This dimension is illustrated as “X” in FIG. 12. The user then slides the application-appropriate tube 22 approximately three-eighths inch, or about “½ X” shown in FIG. 13, over the remaining three quarters of an inch of the original rigid tube 3. The spring-like tube 22 is held in place via friction fit. An appropriate adhesive can also be applied if desired or required. The user then cuts the tube 22 to its proper length so that when the sprayer mechanism 1 is reinstalled, the bottommost end 26 of the spring-like tube 22 extends approximately three-eighths of an inch beyond the bottom of the liquid-dispensing container 2 as shown in FIG. 14. It should be noted that precise placement or level of overlap is not a limitation of the present invention.

Referring now to FIGS. 18A and 18B, they illustrate the result of a prior art attempt to accomplish such an after-market conventional rigid tube 43 replacement. More specifically, the rigid tube 43 of original manufacture is, in accordance with the prior art, cut along a bias 45. As the leading edge of the bias cut 45 is inserted into the interior 46 of the replacement tube 44, the leading edge of the sharp bias cut 45 has a tendency to pierce or eventually wear through the tube 44 at a point 48, thus creating a leakage problem at that puncture point. The device and method of the present invention is intended to address this shortcoming in the prior art and avoid a bias cut 45 as shown in FIGS. 18A and 18B. As mentioned earlier, the original rigid tube 5 is cut at a substantially right angle relative to the axis of the tube 5 in accordance with the present invention. This presents a generally flat and dull surface for the new replacement tube 22 to be installed over and eliminates any prospect of piercing the replacement spring-like tube 22.

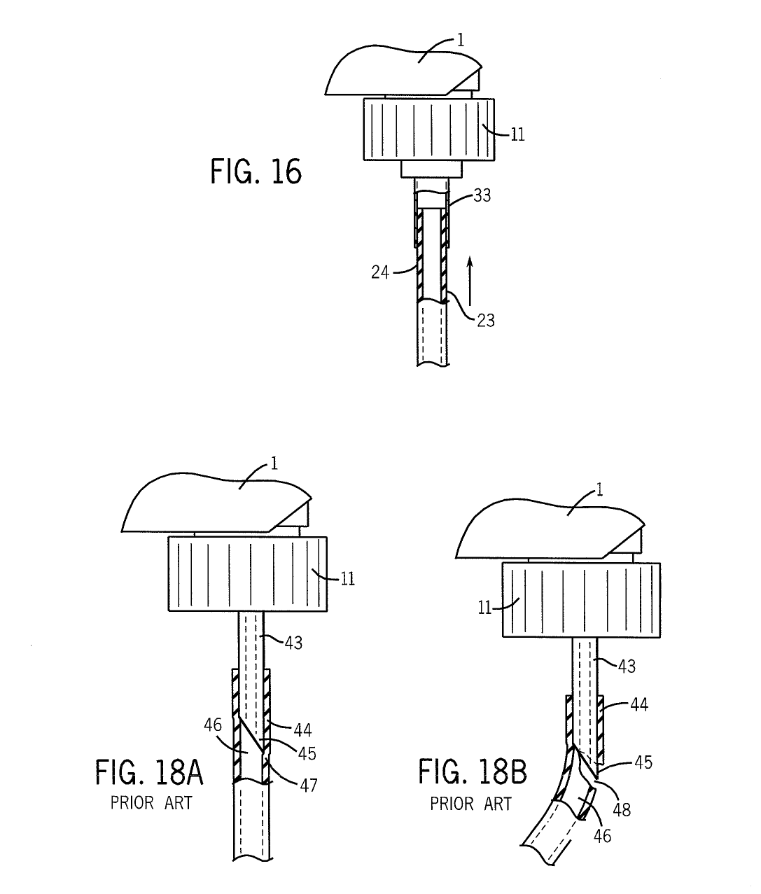

It should also be understood that the dense, non-buoyant and spring-like tube 22 of the present invention can be utilized in such a way that it is functionally adapted to a female-type fitting 33 that would be part of the liquid-dispensing mechanism 1 as shown in FIG. 16. In this way, the uppermost portion 24 of the suction tube 22 would be urged by friction fit into a cavity contained within the female member 33 of the original rigid spray tube assembly 10. A suitable adhesive can also be applied if desired or required.

It is also to be understood that the spring-like tube 22 of the present invention can be easily adapted to modify or retrofit virtually any existing (non-pressurized) removable trigger sprayer or pump sprayer via cutting the rigid tube 5 to a length of that approximates that illustrated in 21. That is, the spring-like tube 22 of the present invention can be used in retrofit as an extension from a shorter length of conventional straight rigid tube 3, as is shown in FIG. 21. Although not necessarily preferred, the spring-like tube 22 of the present invention can be fashioned as an approximate “sixty/forty” or “seventy/thirty” flexible tube 22 and rigid tube 3 assembly, as previously disclosed. As shown in FIG. 21, for purposes of example only, forty percent (40%) of the existing conventional rigid tube 3 of original manufacture is provided and is cut at a point 13a that is substantially lower within the liquid-dispensing container 2. This represents approximately forty percent (40%) of the overall structure of the combined tube 3, 22. On the other hand, the replacement spring-like tube 22 represents about sixty percent (60%) of the overall tube structure 3, 22, the replacement tube 22 being cut at a point 24a. In this way, the interior of the liquid-dispensing container 2 and the liquid product 9 contained within it is still accessed at the distal end 26 of the tube 22 which allows for maximum depletion of the liquid 9 contained within the container 2. Other ratios of original rigid tubing 3 to replacement spring-like tube 22 could be used as well and are clearly within the scope of this invention.

Finally, it is to be understood that the spring-like tube 22 of the present invention is not limited to use within a conventional liquid-dispensing container 2 as is shown in the drawings appended hereto. As shown in FIG. 22, for example, it is to be understood that the spring-like tube 64 could also be attached to a pressurized press nozzle or non-pressurized pump type liquid-dispensing atomizer, generally identified 60, having an atomizer container 62 and a quantity of liquid 69 contained within it typically of perfumes, personal hygiene, food products, and medicine. In this fashion, the distal end 66 of the replacement suction tube 64 reaches within all points at the bottom of the atomizer container 62. Other non-pressurized sprayer containers could be retrofitted with the spring-like tubes 22, 64 of the present invention as well as could other containers of original manufacture.

Based upon the foregoing, it will be seen that there has been provided a new and useful dense, non-buoyant and spring-like tube for use within a liquid-dispensing container that is configured so as to obtain maximum liquid extraction from within the container; that extends well into the interior corners of the container to assure substantially complete evacuation and continuous “on command” dispensing capability of the liquid contents, the tube being adaptable for use with most containers currently available; that facilitates the complete or near-complete evacuation of the liquid contents of the container and uninterrupted “on command” spraying capability when the sprayer mechanism is oriented to spray liquid in a wide variety of vertical or near vertical, as well as horizontal, positions; and that can be used as part of an assemblage for replacing the original conventional rigid tube in a sprayer mechanism of original manufacture with a tube in accordance with the method of the present invention.

The principles of this invention having been fully explained in: connection with the foregoing, I hereby claim as my invention:

1. A tube for use in a liquid-dispensing container, the tube comprising
a longitudinally-extending tube, said tube having a first end and a second end, the first end of said tube being attachable to a spray mechanism, said tube comprising a spring-like action, and
a vacuum-lock regulator valve defined within the second end of the tube.

2. The tube of claim 1 wherein the tube is made of a dense and non-buoyant material.

3. The tube of claim 1 wherein the second end of the tube is formed in a substantially right-angled transverse plane relative to the axial center of the tube.

4. The tube of claim 1 wherein the vacuum-lock regulator valve is configured as at least one aperture at the second end of the tube.

5. The tube of claim 1 wherein the vacuum-lock regulator valve is configured by cutting, forming or molding at least one V-shaped, U-shaped or similar aperture at the second end of the tube.

6. A packaged assemblage for attaching the tube of claim 1 to an existing and/or future liquid-dispensing container of original manufacture.

7. A method for attaching the tube of claim 1 as a replacement tube in an existing and/or future liquid-dispensing container of original manufacture, the spray mechanism of the liquid-dispensing container having a section of original rigid tubing extending downwardly from the spray mechanism, the method comprising the steps of
locating a cutting point along the original rigid tubing,
cutting the original rigid tubing at the cutting point and at a substantially right angle,
sliding the first end of the replacement tube over the remaining portion of the cut original rigid tubing,
measuring the replacement tube length relative to the liquid-dispensing container,
cutting the second end of the replacement tube at a point and at a substantially right angle, and
configuring a vacuum-lock regulator valve at the second end of the replacement tube.

8. The method of claim 7 wherein the combined original rigid tubing and the replacement tube are provided in a proportion such that the overall length of the combined tube and tubing comprises approximately 40% or less of original rigid tubing.

9. A tube for use in a liquid-dispensing container, the container having a spray mechanism, the tube comprising
a longitudinally-extending tube, said tube having a first end and a second end, the first end of said tube being attachable to a section of rigid tubing extending downwardly from the spray mechanism of the liquid-dispensing container, said tube comprising a spring-like action, and
a vacuum-lock regulator valve defined within the second end of the tube.

10. The tube of claim 9 wherein the tube is made of a dense and non-buoyant material.

11. The tube of claim 9 wherein the second end of the tube is formed in a substantially right-angled transverse plane relative to the axial center of the tube.

12. The tube of claim 9 wherein the vacuum-lock regulator valve is configured as at least one aperture at the second end of the tube.

13. The tube of claim 9 wherein the vacuum-lock regulator valve is configured by cutting, forming or molding at least one V-shaped, U-shaped or similar aperture at the second end of the tube.

14. The tube of claim 9 wherein the section of rigid tubing and the spring-like tube are provided in a proportion such that the overall length of the combined tube and tubing comprises approximately 40% or less of rigid tubing.
